(19) United States
(12) Patent Application Publication
(10) Pub. No.: US 2015/0151718 A1
(43) Pub. Date: Jun. 4, 2015

(54) WIPER COUPLER ASSEMBLY AND WIPER ASSEMBLY INCORPORATING SAME

(71) Applicant: TRICO PRODUCTS CORPORATION, ROCHESTER HILLS, MI (US)

(72) Inventor: Kyle Moll, Oxford, MI (US)

(73) Assignee: TRICO PRODUCTS CORPORATION, ROCHESTER HILLS, MI (US)

(21) Appl. No.: 14/094,229

(22) Filed: Dec. 2, 2013

(51) Int. Cl. B60S 1/40

(52) U.S. Cl. CPC B60S 1/4048; B60S 2001/4051

(57) ABSTRACT

A wiper coupler assembly for releasably attaching a wiper assembly to a wiper arm includes a wiper coupler adapted for connection to the wiper assembly and a wiper coupler adaptor connected to the wiper coupler and adapted for connection to an attachment member of the wiper arm. The wiper coupler adaptor includes a pair of sidewalls extending longitudinally and a deck disposed between the sidewalls to define a rest that is adapted to operatively receive a track between rails of the attachment member. Each of the sidewalls includes a post that extends laterally toward the other and disposed in bores of the wiper coupler. Each of the sidewalls includes a retention member extending outwardly and longitudinally therealong adapted to operatively engage a corresponding retention guide in the rails of the attachment member.

### BACKGROUND OF THE INVENTION

1. Field of the Invention

The present invention relates generally to wiper assemblies and, more specifically, to a wiper coupler assembly and wiper assembly incorporating same for use in connecting the wiper assembly to a wiper arm of a vehicle.

2. Description of the Related Art

Conventional wiper systems for vehicles known in the related art include some type of wiper assembly mounted to a wiper arm which, in turn, is mounted adjacent a surface to be wiped such as a windshield of the vehicle and pivotally driven to impart reciprocal motion to the wiper assembly across the windshield. The wiper assembly typically includes a rubber wiping element that contacts the windshield across the surface to be wiped. The wiper assembly often incorporates a support member formed as one or more metal strips that act to reinforce the wiping element and facilitate wiping contact by the wiping element across what is typically a curved glass surface. In this context, the wiper arm delivers a downward force to the wiper assembly that is distributed thereacross pressing the wiper assembly into contact with the windshield. The wiper assembly may also include an airfoil and a pair of end caps located at the distal ends of the wiper assembly. The wiper assembly may also include a wiper coupler assembly that connects the wiper assembly to the wiper arm.

In some wiper systems, the wiper arm may include an attachment member at the free end thereof for attachment to the wiper coupler assembly of the wiper assembly. In addition, the wiper coupler assembly may include a wiper coupler adaptor that is operatively mounted to a wiper coupler of the wiper assembly and is employed for connection to the attachment member of the wiper arm. A typical wiper coupler connection, for example a side pinch with a lateral pull or over center configuration, connects the wiper coupler adaptor to the attachment member of the wiper arm and can be disassembled. This type of connection has a relatively high profile and height on the windshield.

As a result, it is desirable to provide a wiper coupler assembly that enhances the retention of the wiper coupler adaptor to the wiper arm during operation. It is also desirable to reduce the height of the wiper assembly on the windshield. Accordingly, there is a need in the art for a wiper coupler assembly that operatively attaches a wiper assembly to a wiper arm. In addition, there is a need in the art for a wiper coupler assembly that operatively engages a wiper arm for a wiper assembly.

### SUMMARY OF THE INVENTION

The present invention overcomes many limitations and disadvantages in the related art in a wiper coupler assembly, as well as a wiper assembly, for use in connection with an attachment member of a wiper arm. The wiper coupler assembly includes a wiper coupler adapted for connection to the wiper assembly and a wiper coupler adaptor connected to the wiper coupler and adapted for connection to an attachment member of the wiper arm. The wiper coupler includes a base portion adapted for connection to the wiper assembly and an attachment portion extending from the base portion and having a pair of opposed bores extending laterally toward the other. The wiper coupler adaptor includes a pair of sidewalls extending longitudinally and a deck disposed between the sidewalls to define a rest that is adapted to operatively receive a track between rails of the attachment member. Each of the sidewalls includes a post that extends laterally toward the other and disposed in the bores of the wiper coupler, each of the sidewalls includes a retention member extending outwardly and longitudinally therealong adapted to operatively engage a corresponding retention guide in the rails of the attachment member.

In addition, the present invention is a wiper coupler assembly for releasably attaching a wiper assembly to a wiper arm including an attachment member adapted to extend from the wiper arm having a base extending longitudinally and a pair of rails extending longitudinally from the base to define a track, each of the sidewalls including a retention guide extending longitudinally therein. The wiper coupler assembly also includes a wiper coupler adapted for connection to the wiper assembly. The wiper coupler includes a base portion adapted for connection to the wiper assembly and an attachment portion extending from the base portion and having a pair of opposed bores extending laterally toward the other. The wiper coupler assembly further includes a wiper coupler adaptor having a pair of sidewalls extending longitudinally and a deck disposed between the sidewalls to define a rest to operatively receive the track between the rails of the attachment member. Each of the sidewalls includes a post that extends laterally toward the other and disposed in the bores of the wiper coupler to connect to the wiper coupler. Each of the sidewalls includes a retention member extending outwardly and longitudinally therealong to operatively engage the retention guide of the attachment member to connect the wiper coupler adaptor to the attachment member.

Thus, one advantage of the present invention is that a new wiper coupler assembly is provided to operatively engage a wiper assembly to a wiper arm. Another advantage of the present invention is that the wiper coupler assembly includes a wiper coupler adaptor and attachment member that will reduce the overall height of the wiper assembly on a windshield of the vehicle. Yet another advantage of the present invention is that the wiper coupler adaptor and attachment member allows reduced height to minimize and hide the view of the wiper assembly on a vehicle when it is parked, improving the aesthetics of the vehicle and meeting customer requirements for down vision from the driver's perspective. Still another advantage of the present invention is that the wiper coupler adaptor remains affixed to the wiper arm in which a wiper assembly first locks into the adaptor and the adaptor slides in to the attachment member to secure the wiper arm and the wiper assembly together. Yet a further advantage of the present invention is that the wiper coupler adaptor and attachment member reduce the height of the wiper assembly on the windshield by having the adaptor with a lower rotational center for the wiper assembly and an arm retention that is incorporated in the sidewall of the adaptor and attachment member, thereby reducing the overall height of the wiper assembly.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of a front of a vehicle having a wiper system, according to the present invention with a pair of wiper assemblies and wiper arms pivotally mounted for reciprocal movement across a windshield of the vehicle.

FIG. 2 is an enlarged perspective view of one of the wiper assemblies, according to one embodiment of the present invention, and one of the wiper arms of the wiper system of FIG. 1.

FIG. 3 is a perspective view of the wiper assembly, according to one embodiment of the present invention, of FIG. 2.

FIG. 4 is an exploded view of a wiper coupler assembly and attachment member, according to one embodiment of the present invention, and a portion of the wiper assembly and wiper arm of FIG. 2.

FIG. 5 is a top plan view of a wiper coupler, according to one embodiment of the present invention, of the wiper coupler assembly of FIG. 4.

FIG. 6 is a sectional view taken along line 6-6 of FIG. 5.

FIG. 7 is a top perspective view of a wiper coupler adaptor, according to one embodiment of the present invention, of the wiper coupler assembly of FIG. 4.

FIG. 8 is another top perspective view of the wiper coupler adaptor of FIG. 7 in accordance with one embodiment of the present invention.

FIG. 9 is a bottom perspective view of the wiper coupler adaptor of FIG. 7 in accordance with one embodiment of the present invention.

FIG. 10 is another bottom perspective view of the wiper coupler adaptor of FIG. 7 in accordance with one embodiment of the present invention.

FIG. 11 is a perspective exploded view of the wiper coupler assembly of FIG. 4 operatively engaging the wiper assembly and the attachment member of FIG. 4 in a first position.

FIG. 12 is a perspective view of the wiper coupler assembly of FIG. 4 operatively engaging the wiper assembly and the attachment member of FIG. 4 in a second position.

### DETAILED DESCRIPTION OF THE PREFERRED EMBODIMENT(S)

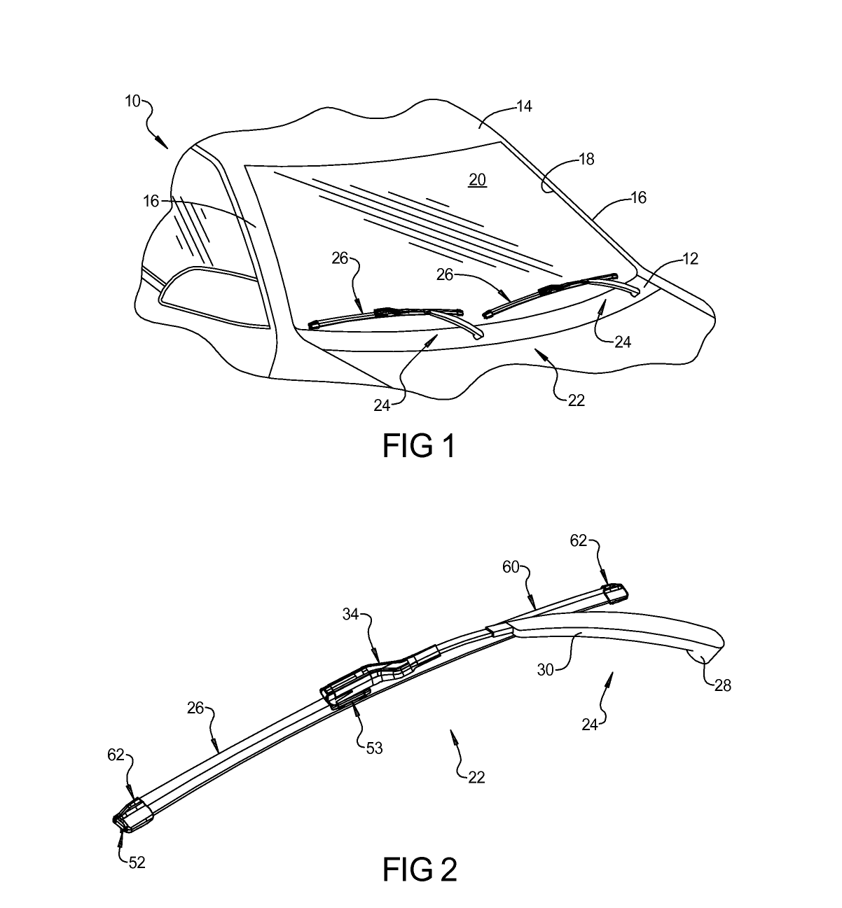

Referring now to the figures, where like numerals are used to designate like structure, a portion of a vehicle is schematically illustrated at 10 in FIG. 1. The vehicle 10 includes a cowl 12, a roof 14, and a pair of laterally spaced front or “A” pillars 16 extending between the roof 14 and the cowl 12. The A-pillars 16, roof 14, and cowl 12 cooperate to define a generally rectangular opening 18 in which is supported a curved or “swept back” glass windshield 20.

A wiper system is generally indicated at 22 in FIG. 1 and is employed to wipe or clean the windshield 20. The wiper system 22 includes a wiper arm, generally indicated at 24, and a wiper assembly, generally indicated at 26. Those having ordinary skill in the art will appreciate that a wiper system 22 may include more than one wiper arm 24 and more than one wiper assembly 26. By way of example and as indicated in FIG. 1, a wiper system 22 may include a pair of wiper arms 24 and wiper assemblies 26, which correspond to the driver and passenger side of the vehicle 10.

Referring to FIG. 2, the wiper arm 24 includes a pivot end 28 operatively attached to an electrical motor (not shown) of the wiper system 22 to move the wiper arm 24 across the surface to be wiped in an oscillating manner. The wiper arm 24 further includes an elongate body 30 that extends outward from the pivot end 28 and a connector or attachment member 34, according to one embodiment of the present invention and described in greater detail below, at a free end of the elongate body 30. The elongate body 30 includes a predetermined length to direct the wiper assembly 26 across the appropriate surface area. Accordingly, it will be appreciated that the predetermined length of the elongate body 30 will vary depending on the surface area to be wiped. Furthermore, those having ordinary skill in the art will appreciate that the elongate body 30 may be jointed for movement away from the surface to be wiped in order to facilitate replacement of the wiper assembly 26 when worn or to perform other maintenance or repair to the wiper system 22 or adjacent area of the vehicle 10. In addition to these elements, the wiper arm 24 may further include a biasing member (not shown), such as a spring, to provide a biasing force that facilitates contact between the wiper assembly 26 and the windshield 20 of the vehicle 10.

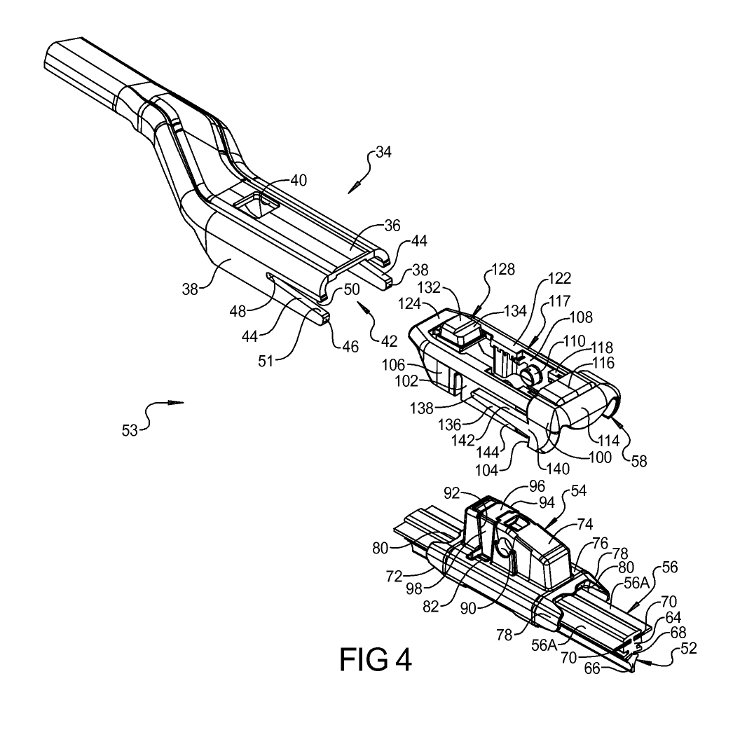

Referring to FIGS. 2 and 4, the wiper arm 24 further includes an attachment member, according to one embodiment of the present invention and generally indicated at 34, disposed at or adjacent to the end of the elongate body 30, opposite the pivot end 28. The attachment member 34 is adapted to operatively engage the wiper assembly 26, as will be described in greater detail below. The attachment member 34 includes a base 36 and a pair of rails 38 depending from the base 36 and aligned with respect to each other to form a generally inverted “U” shape cross-section. The base 36 includes an aperture 40 extending therethrough. The aperture 40 is spaced from the free end of the base 36. The aperture 40 is generally rectangular in shape, but may be any suitable shape. The base 36 and rails 38 cooperate to define a track, generally indicated at 42, to operatively receive a portion of the wiper assembly 26, as will be described in greater detail below. Each of the rails 38 includes a retention guide 44 that extends linearly relative to the rails 38. Each of the retention guides 44 is a slot having a leading edge 46 and a trailing edge 48, the function of each will be described in greater detail below. The slot has an upper edge 50 and a lower edge 51 forming a generally “V” shaped. The lower edge 51 is angled relative to the upper edge 50, such that the upper edge 50 and lower edge 51 form an acute angle. However, those having ordinary skill in the art will appreciate that lower edge 51 may also extend substantially parallel relative to the upper edge 50 without departing from the scope of the invention.

Referring to FIGS. 2 through 4, the wiper assembly 26 includes a wiping element, generally indicated at 52, that is adapted to contact the surface of the vehicle 10 to be wiped, in this representative example, the windshield 20. In addition, the wiper assembly 26 also includes a wiper coupler assembly, according to one embodiment of the present invention and generally indicated at 53, to connect the wiper assembly 26 to the attachment member 34 of the wiper arm 24. The wiper coupler assembly 53 includes a wiper coupler, according to one embodiment of the present invention and generally indicated at 54, connected to a support member 56 to be described of the wiper assembly 26 and a wiper coupler adaptor, according to one embodiment of the present invention and generally indicated at 58, that acts to interconnect the wiper coupler 54 of the wiper assembly 26 and the attachment member 34 of the wiper arm 24. The wiper assembly 26 also includes an elongated support member, generally indicated at 56, that defines a longitudinal axis and that acts to support the wiping element 52. In the representative embodiment illustrated herein, the support member 56 is a pair of splines 56A to operatively reinforce or support the wiping element 52. The wiper assembly 26 may also include an airfoil assembly, generally indicated at 60, and a pair of end caps, generally indicated at 62. It should be appreciated that the attachment member 34 is operatively attached to the wiper assembly 26 via the wiper coupler assembly 53.

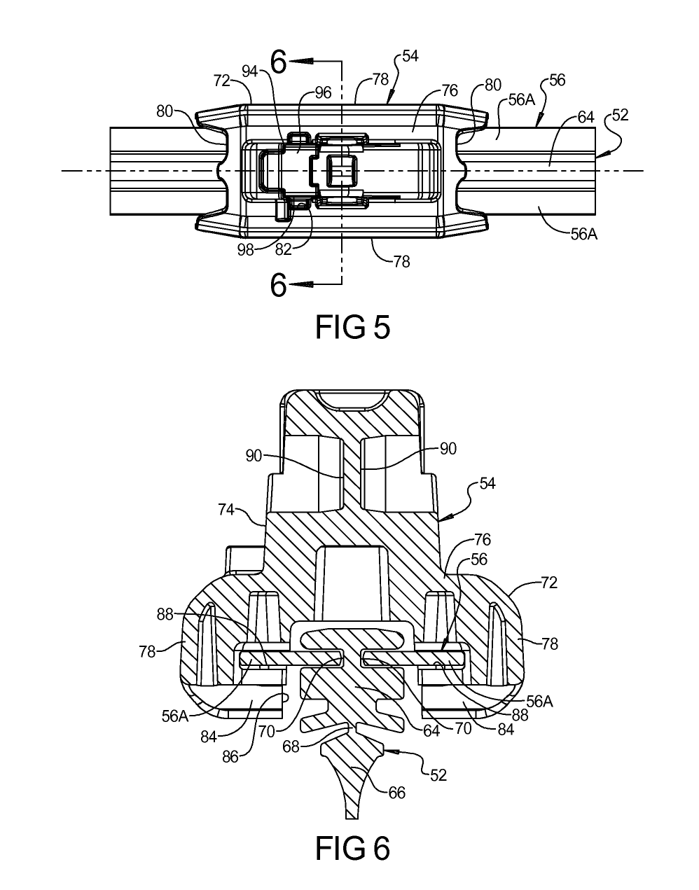

As illustrated in FIGS. 4 and 6, the wiping element 52 includes an upper section or portion 64 and a lower section or portion 66 that are partitioned by a longitudinally extending bridge section or portion 68. The bridge portion 68 provides flexibility between the upper portion 64 and lower portion 66 during operational movement of the wiper assembly 26 across the surface to be wiped. In the embodiment illustrated, the upper portion 64 includes opposed grooves 70 extending laterally therein and longitudinally therealong between its ends. The grooves 70 receive the splines 56A and the splines 56A cooperate with the wiper coupler 54 as will be described in detail below. The wiping element 52 has a predetermined length corresponding to particular application and is often manufactured through an extrusion process, which enables the length of the wiping element 52 to be easily adjusted without a substantial increase to manufacturing expense. Furthermore, while the wiping element 52 of the present invention is constructed from a flexible rubber, those having ordinary skill in the art will appreciate that it may be constructed from any flexible material such as silicone or other polymer without departing from the scope of the present invention.

The support member 56 may be constructed from a resiliently flexible material, such as spring steel or a polymer, and is adapted to apply force from an intermediate position between the longitudinal ends to the longitudinal ends. More specifically, the support member 56 receives force from the spring-loaded wiper arm 24 at an intermediate position and distributes this force across the span of the support member 56 toward the longitudinal ends. To that end, the support member 56 may be curved longitudinally with a predetermined radius of curvature. This predetermined radius of curvature is sometimes referred to in the related art as a “free form” radius of curvature. Accordingly, the curvature of the support member 56 may be symmetrical or asymmetrical depending on the force requirements and the contour of the windshield 20. The flexible, free form, pre-curved support member 56 straightens out when the wiper arm 24 applies a force thereto to flatten the support member 56 and directs the wiping element 52 to contact the windshield 20. Thus, the elongated support member 56 includes a free-form curvature that ensures force distribution on windshields having various curvatures that effects proper wrapping about the windshield 20.

In the representative embodiment illustrated herein, the support member 56 is generally rectangular in shape and extends longitudinally. However, those having ordinary skill in the art will appreciate that the support member 56 may be either defined by a monolithic beam or defined by the pair of rails 56A. As illustrated throughout the figures, the support member 56 has a substantially constant width and may have a constant thickness throughout the length between the longitudinal ends. The constant width and thickness are adapted to provide high lateral and torsional stiffness to avoid lateral and torsional deflection, which causes the wiping element 26 to stick/slip (“chatter”) on the windshield 20 during operation. Thus, the cross-section of the support member 56 has a generally rectangular outer profile that makes the elongated support member 56 easier to manufacture. More specifically, where the support member 56 is constructed from metal, such as spring steel, the tools and machinery used to manufacture the support member 56 are less complicated than that required to manufacture having varying widths and/or thicknesses. Furthermore, where the support member 56 is constructed from a polymer, such as a thermoplastic elastomer, the tools and extrusion process machinery are also less complicated than those employed to manufacture having varying widths and/or thicknesses. However, those having ordinary skill in the art will appreciate that the support member 56 illustrated herein may include a varying thickness and/or width without departing from the scope of the present invention.

As previously noted, the wiper assembly 26 may include the airfoil assembly, generally indicated at 60, to prevent the wiping assembly 26 from lifting from the surface of the windshield 20. The airfoil assembly 60 is operatively mounted to the support member 34. The airfoil assembly 60 extends along the length of the support member 34. The airfoil assembly 60 acts to reduce the likelihood of wind lift by allowing air to flow over the wiper assembly 26. More specifically, and in the embodiment illustrated herein, the airfoil assembly 60 includes a pair of airfoil components 60A that are operatively mounted to the support member 56 with the wiper coupler assembly 53 extending therebetween. However, those having ordinary skill in the art will appreciate that the airfoil assembly 60 may be defined by a single unitary component without departing from the scope of the present invention.

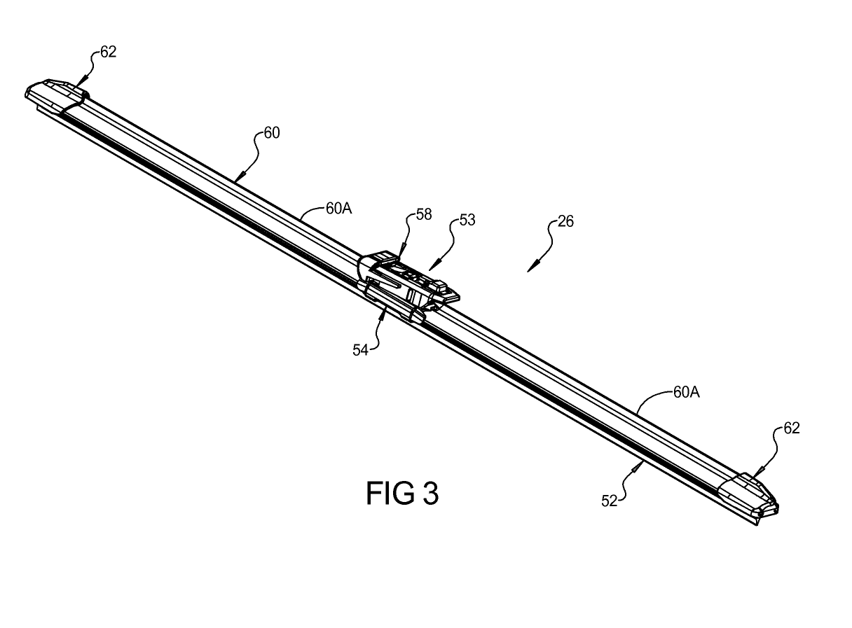

As illustrated in FIGS. 2 and 3, the wiper assembly 26 may include the pair of end caps, generally indicated at 62. The end caps 62 are adapted to be disposed adjacent to the distal ends of the airfoil components 60A. The end caps 62 are secured to the support member 56. The end caps 62 include a profile that substantially mimics the contours of the airfoil assembly 60 to maintain the wind lift characteristics of the wiper assembly 26 and to provide an increased aesthetic value. The end caps 62 also provide a mass increase adjacent the distal ends of the airfoil components 60A that prevent localized chatter along the extremities of the wiping element 52 caused by the combination of wind lift and a decrease in the force distributed to this area from wiper arm 24 via the splines 56A, as above-described. It should be appreciated that the end caps 62 may have a locking arm (not shown) to engage notches (not shown) in the splines 56A of the support member 56.

Referring to FIGS. 2 through 4, the wiper assembly 26 further includes the wiper coupler assembly, according to one embodiment of the present invention and generally indicated at 53, to couple the wiper assembly 26 to the attachment member 34 of the wiper arm 24. The wiper coupler assembly 53 includes the wiper coupler, according to one embodiment of the present invention and generally indicated at 54, connected to the support member 56 and the wiper coupler adaptor, according to one embodiment of the present invention and generally indicated at 58, that acts to interconnect the wiper coupler 54 of the wiper assembly 26 and the attachment member 34 of the wiper arm 24.

Referring to FIGS. 4 through 6, one embodiment of the wiper coupler 54 includes a base portion 72 for attaching to the support member 56 and an attachment portion 74 that extends outwardly away from the base portion 72 for attaching to the wiper coupler adaptor 58. The base portion 72 includes a top wall 76 and a pair of side walls 78 extending from the top wall 76. The top wall 76 is generally rectangular in shape, but may be any suitable shape. The top wall 76 may have one or more recess 80 extending longitudinally therein to cooperate with an end portion of the airfoil component 60A. The top wall 76 also has an aperture 82 extending therethrough. The aperture 82 is generally rectangular in shape, but may be any suitable shape. The side walls 78 are generally rectangular in shape, but may be any suitable shape, and extend generally perpendicular from each longitudinal side of the top wall 76. The base portion 72 includes a flange wall 84 extending laterally inwardly from each of the side walls 78 to form a space or channel 86 therebetween extending longitudinally to receive the wiping element 52. The flange walls 84 each have a groove 88 extending laterally therein and longitudinally therealong to receive one of the splines 56A of the support member 56. It should be appreciated that the base portion 72 is mounted to the support member 56.

The attachment portion 74 extends generally perpendicular from the top wall 76 of the base portion 72. In one embodiment, the attachment portion 74 is generally rectangular in shape, but may be any suitable shape. The attachment portion 74 may include opposed recessed portions or bores 90 extending laterally therein to receive the wiper coupler adaptor 58 to be described. The attachment portion 74 may include an aperture 92 spaced longitudinally from the bores 90 and extending inwardly from the top thereof. The aperture 92 is generally “V” shaped and communicates with the aperture 82 in the top wall 76 of the base portion 72. The wiper coupler 54 is made of a rigid material such as plastic. The wiper coupler 54 is integral, unitary, and one-piece.

The wiper coupler 54 may include a retention clip 94 to separate the splines 56A of the support member 56 and to retain the splines 56A of the support member 56. The retention clip 94 includes a top wall 96 and side walls 98 extending from the top wall 96 to form a general inverted “U” shape. Each side wall 98 extends into one of the apertures (not shown) in the splines 56A to prevent longitudinal movement relative to each other.

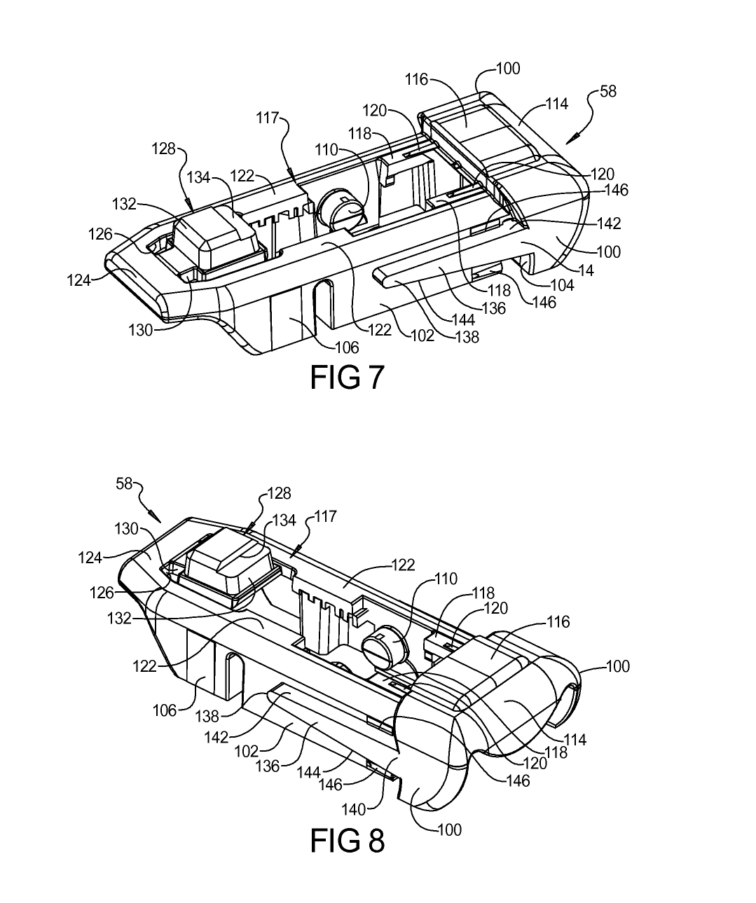

Referring to FIGS. 4 and 7 through 10, one embodiment of the wiper coupler adaptor 58 includes a pair of sidewalls 100 extending longitudinally. Each of the sidewalls 100 include a recessed section 102 extending longitudinally therein and adapted to operatively engage the rails 38 of the attachment member 34. The recessed section 102 is partially defined within the sidewalls 100 by an end lip 104 that is adapted to provide a positive stop with respect to the rails 42 of the attachment member 34 when the wiper assembly 26 is attached to the wiper arm 24. The recessed section 102 further includes at least one raised facade 106 to provide an interference fit between the wiper coupler adaptor 58 and the rails 38 of the attachment member 34. Those having ordinary skill in the art will appreciate that the raised facade 106 also provides additional support to the sidewalls 100 and that the recessed section 102 may include more than one raised facade 106.

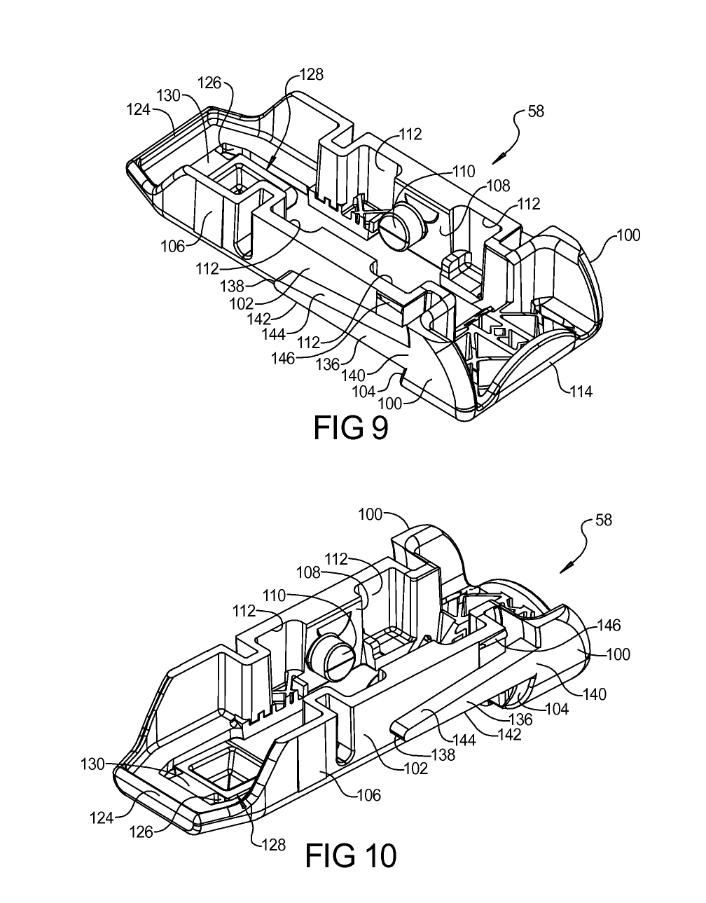

As illustrated in FIGS. 9 and 10, each of the sidewalls 100 further includes an inward surface 108 facing each other. The inward surfaces 108 include posts 110 that extend transversely or laterally from their respective inward surface 108 and toward each other. The posts 110 operatively engage aligned bores 90 of the wiper coupler 54 and provide a bearing surface about which the wiper coupler adaptor 58 and wiper coupler 54 may pivot relative to each other. The inward surfaces 108 also include one or more recesses 112 spaced longitudinally from the posts 110 to provide clearance.

Referring to FIGS. 4 and 7 through 10, the wiper coupler adaptor 58 further includes an end wall 114 disposed between the sidewalls 100. The end wall 114 may include a raised portion 116 disposed between the sidewalls 100. The wiper coupler adaptor 58 also includes a deck, generally indicated at 117, disposed between the sidewalls 100 and extending longitudinally to receive the track 42 of the attachment member 34. The deck 117 further includes one more rear platforms 118 disposed between the sidewalls 100 adjacent the end wall 114. The rear platforms 118 include a raised portion 120 that is adapted to provide an interference fit against the track 44 of the attachment member 34. The deck 117 also includes one or more forward platforms 122 disposed between the sidewalls 100 and spaced longitudinally from the rear platforms 118. The deck 117 further includes an end platform 124 disposed between the sidewalls 100 that cooperates with the sidewalls 100 and the forward platforms 122 to define an aperture 126 therebetween. Those having ordinary skill in the art will appreciate that the end platform 124 additionally provides structural support between the sidewalls 100.

The wiper coupler adaptor 58 further includes an engaging member or snap bridge, generally indicated at 128, that is disposed within the aperture 126. The snap bridge 128 depends from the end platform 124 and includes a cantilevered body 130 and a head 132 disposed at the terminal end of the cantilevered body 130 to cooperate with the aperture 40 in the attachment member 34. The head 132 is generally rectangular in shape, but may be any suitable shape. The head 130 also includes a recessed portion 134 therein. The recessed portion 134 is adapted to receive a portion of the aperture 40 of the attachment member 34 to prevent undesired release of the wiper coupler adaptor 58 from the attachment member 34. More specifically, the recessed portion 134 provides an interference fit between a portion of the aperture 40 of the attachment member 34 and the snap bridge 128.

The wiper coupler adaptor 58 further includes a retention member 136 that extends linearly from the sidewalls 100 and into the recessed portions 102 thereof. Each of the retention members 136 is a projection having a leading edge 138 and a trailing edge 140, the function of each will be described in greater detail below. The retention member 136 also has an upper edge 142 and a lower edge 144 forming a generally “V” shaped. The lower edge 144 is angled relative to the upper edge 142, such that the upper edge 142 and lower edge 144 form an acute angle. However, those having ordinary skill in the art will appreciate that lower edge 144 may also extend substantially parallel relative to the upper edge 142 without departing from the scope of the invention. It should also be appreciated that the wiper coupler adaptor 58 may include one or more raised portions 146 extending into the recessed portions 102 near the trailing edge 140 of the guide members 136 that is adapted to provide an interference fit against the track 42 of the attachment member 34.

In operation, the wiper assembly 26 is assembled by sliding the splines 56A of the support member 56 in the grooves 70 of the wiping element 52. Next, the wiper coupler 54 is slid over the support member 56 such that the splines 56A are disposed in the grooves 88 and the wiping element 52 is disposed in the channel 86 of the base portion 72 until the wiper coupler 54 is centered along the support member 56. After that, the retention clip 94 is slid into the wiper coupler 54. The retention clip 94 is slid into the aperture 92 of the attachment portion 74 of the wiper coupler 54 to lock the retention clip 94 and the wiper coupler 54 together. When this occurs, the side walls 98 of the retention clip 94 are disposed in the apertures of the splines 56A. Next, the airfoil components 60A are slid over the support member 56 and one of the longitudinal ends is disposed in the recess 80 of the wiper coupler 54. Next, the end caps 62 are slid over the support member 56 such that the notches in the splines 56A are engaged to retain the end caps 62 to the support member 56.

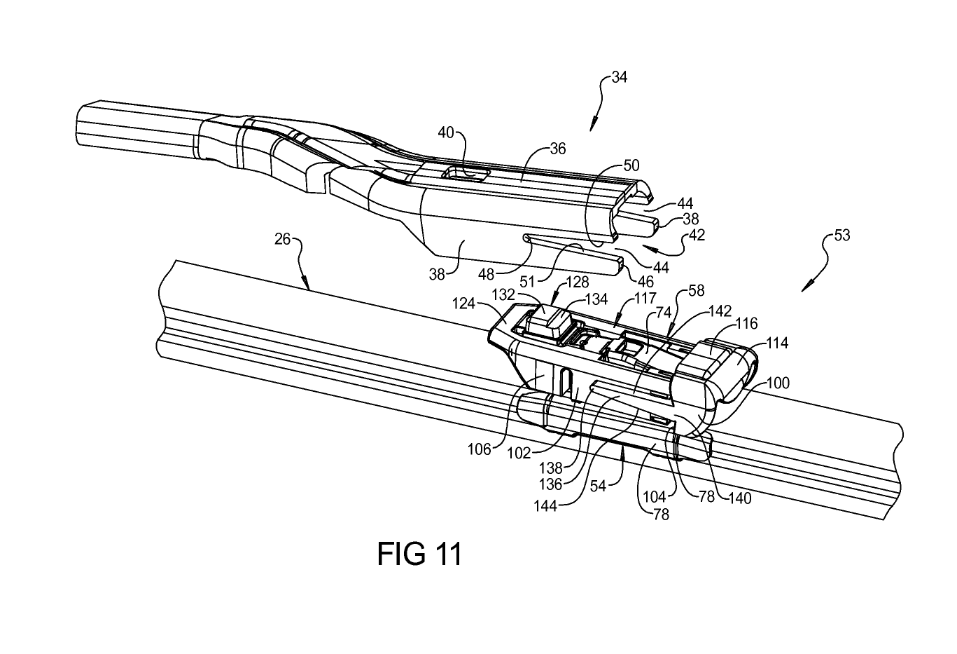

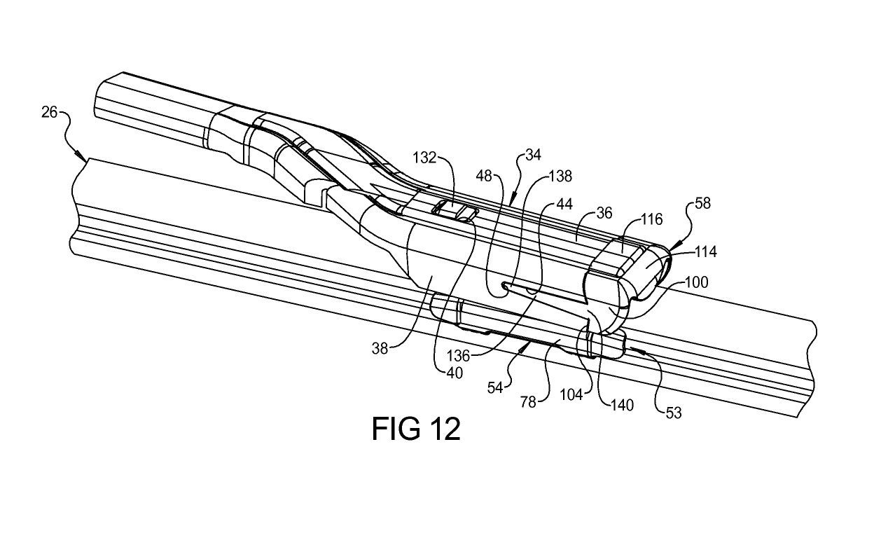

In operation, FIGS. 11 and 12 illustrate the attachment of the wiper assembly 26 to the wiper arm 24. As illustrated in FIG. 11, the wiper coupler adaptor 58 is properly assembled when the wiper coupler adaptor 58 is seated adjacent the wiper coupler 54 and the aligned posts 110 operatively engage the aligned bores 90. As illustrated in FIG. 12, the wiper assembly 26 is properly attached to the wiper arm 24 by moving the wiper coupler adaptor 58 toward the attachment arm 34 and the retention members 136 are slid into the retention guides 44 until the leading edge 138 of the retention members 136 is adjacent the trailing edge 48 of the retention guides 44 and the upper edges 50, 142 and lower edges 51, 144 are adjacent each other to provide an interference fit therebetween. As illustrated in FIG. 12, the snap bridge 128 rotates such that the head 132 is disposed in the aperture 40 of the attachment member 34 and locks the attachment member 34 in place with the wiper coupler adaptor 58 to prevent undesired release of the wiper coupler adaptor 58 from the attachment member 34. It should be appreciated that the snap bridge 128 secures the wiper assembly 26 from a lateral pull to disassemble.

On the other hand, replacement of the wiper assembly 26 of the present invention illustrated in FIGS. 11 and 12 is accomplished by applying force to the head 132 in a direction toward the end platform 124, thereby disengaging the head 132 from contact with the aperture 40 in the attachment member 34 and sliding the wiper coupler adaptor 58 away from the attachment member 34 such that the retention member 136 disengage the retention guides 44. Removal of the wiper assembly 26 from the wiper arm 24 is achieved when the leading edge 138 of the retention member 136 disengages from the leading edge 46 of the retention guides 44.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A wiper coupler assembly for releasably attaching a wiper assembly to a wiper arm, said wiper coupler adaptor comprising:
a wiper coupler adapted for connection to the wiper assembly;
a wiper coupler adaptor connected to said wiper coupler and adapted for connection to an attachment member of the wiper arm;
said wiper coupler including a base portion adapted for connection to the wiper assembly and an attachment portion extending from said base portion and having a pair of opposed bores extending laterally toward the other;
said wiper coupler adaptor including a pair of sidewalls extending longitudinally and a deck disposed between said sidewalls to define a rest that is adapted to operatively receive a track between rails of the attachment member; and
each of said sidewalls including a post that extends laterally toward the other and disposed in said bores of said wiper coupler, each of said sidewalls including a retention member extending outwardly and longitudinally therealong adapted to operatively engage a corresponding retention guide in the rails of the attachment member.

2. A wiper coupler assembly as set forth in claim 1 wherein said retention member is generally “V” shaped.

3. A wiper coupler assembly as set forth in claim 1 wherein said retention member has a leading end and a trailing end, said leading end having a height less than said trailing end.

4. A wiper coupler assembly as set forth in claim 1 wherein said retention member has an upper edge and a lower edge, said upper edge extending linearly and said lower edge extending at an acute angle relative to said upper edge.

5. A wiper coupler assembly as set forth in claim 1 wherein said wiper coupler adaptor includes a snap bridge adapted to be received in an aperture of the attachment member to prevent undesired release of said wiper coupler adaptor from the attachment member.

6. A wiper coupler assembly for releasably attaching a wiper assembly to a wiper arm, comprising:
an attachment member adapted to extend from the wiper arm including a base extending longitudinally and a pair of rails extending longitudinally from said base to define a track, each of said sidewalls including a retention guide extending longitudinally therein;
a wiper coupler adapted for connection to the wiper assembly, said wiper coupler including a base portion adapted for connection to the wiper assembly and an attachment portion extending from said base portion and having a pair of opposed bores extending laterally toward the other; and
a wiper coupler adaptor including a pair of sidewalls extending longitudinally and a deck disposed between said sidewalls to define a rest to operatively receive said track between said rails of said attachment member, each of said sidewalls including a post that extends laterally toward the other and disposed in said bores of said wiper coupler to connect to said wiper coupler, each of said sidewalls including a retention member extending outwardly and longitudinally therealong to operatively engage said retention guide of said attachment member to connect said wiper coupler adaptor to said attachment member.

7. A wiper coupler assembly as set forth in claim 6 wherein said retention guide comprises a slot extending into each of said rails from a free end thereof.

8. A wiper coupler assembly as set forth in claim 7 wherein said slot is generally “V” shaped.

9. A wiper coupler assembly as set forth in claim 7 wherein said slot has a leading end and a trailing end, said leading edge having a height greater than said trailing edge.

10. A wiper coupler assembly as set forth in claim 7 wherein said slot has an upper edge and a lower edge, said upper edge extending linearly and said lower edge extending at an acute angle relative to said upper edge.

11. A wiper coupler assembly as set forth in claim 6 wherein said base of said attachment member includes an aperture spaced from a free end thereof.

12. A wiper coupler assembly as set forth in claim 11 wherein said aperture is generally rectangular in shape.

13. A wiper coupler assembly as set forth in claim 11 wherein said wiper coupler adaptor includes a snap bridge disposed in said aperture of said attachment member to prevent undesired release of said wiper coupler adaptor from said attachment member.

14. A wiper coupler assembly as set forth in claim 6 wherein said retention guide is generally “V” shaped.

15. A wiper coupler assembly as set forth in claim 6 wherein said retention guide has a leading end and a trailing end, said leading end having a height less than said trailing end.

16. A wiper coupler assembly as set forth in claim 6 wherein said retention guide has an upper edge and a lower edge, said upper edge extending linearly and said lower edge extending at an acute angle relative to said upper edge.

17. A wiper assembly for use in connection with a wiper arm having an attachment member, said wiper assembly comprising:
a wiping element adapted to contact a surface to be wiped;
a support member operatively mounted to said wiping element;
a wiper coupler operatively mounted to said support member; and
a wiper coupler adaptor operatively mounted to said wiper coupler and the attachment member that is adapted to releasably attach said wiper coupler to the attachment member, said wiper coupler adaptor including a pair of sidewalls extending longitudinally, and a deck disposed between said sidewalls to define a rest that is adapted to operatively receive a track between the rails of the attachment member, each of said sidewalls including a post that extends laterally toward the other and disposed in bores of said wiper coupler to connect to said wiper coupler, said sidewalls including a plurality of guide members extending outwardly and longitudinally therealong to operatively engage retention guides of the attachment member to connect said wiper coupler adaptor to the attachment member.

18. A wiper assembly as set forth in claim 17 wherein each of said retention members have a leading end and a trailing end, said leading end having a height less than said trailing end.

19. A wiper assembly as set forth in claim 17 wherein each of said retention members have an upper edge and a lower edge, said upper edge extending linearly and said lower edge extending at an acute angle relative to said upper edge.

20. A wiper assembly as set forth in claim 17 wherein said wiper coupler adaptor includes a snap bridge adapted to be disposed within an aperture of the attachment member to prevent undesired release of said wiper coupler adaptor from the attachment member.

21. A wiper system for a vehicle comprising:
at least one wiper arm adapted to be connected to a source of movement, said at least one wiper arm having an attachment member at a free end thereof, said attachment member comprising a base extending longitudinally and a pair of rails extending longitudinally from said base to define a track therebetween, said rails including retention guides extending longitudinally therein; and
at least one wiper assembly having a wiping element adapted to contact a surface to be wiped, a support member to support said wiping element, a wiper coupler connected to said support member and including a base portion connected to said support member and an attachment portion extending from said base portion and having a pair of opposed bores extending laterally toward the other; and
a wiper coupler adaptor including a pair of sidewalls extending longitudinally and a deck disposed between said sidewalls to define a rest to operatively receive said track between said rails of said attachment member, each of said sidewalls including a post that extends laterally toward the other and disposed in said bores of said wiper coupler to connect to said wiper coupler, said sidewalls including a plurality of retention members extending outwardly and longitudinally therealong to operatively engage said retention guides of said attachment member to connect said wiper coupler adaptor to said attachment member.
